(19) United States
(12) Patent Application Publication
(10) Pub. No.: US 2024/0388141 A1
(43) Pub. Date: Nov. 21, 2024

(54) Transmitter Device with Visualization Unit for Wirelessly Powering Receiver Devices

(71) Applicant: Huawei Digital Power Technologies Co., Ltd., Shenzhen (CN)

(72) Inventors: Fralett Suarez Sandoval, Munich (DE); Sarai Malinal Torres Delgado, Munich (DE)

(21) Appl. No.: 18/785,320

(22) Filed: Jul. 26, 2024

Related U.S. Application Data
(63) Continuation of application No. PCT/EP2022/052013, filed on Jan. 28, 2022.

(51) Int. Cl. H02J 50/90; H02J 50/12; H02J 50/40; H02J 50/80

(52) U.S. Cl. CPC H02J 50/90; H02J 50/12; H02J 50/402; H02J 50/80

(57) ABSTRACT

A transmitter device wirelessly powers at least one receiver device and comprises a power source for providing electric power; and a visualization unit; and at least one coil electrically connected to the power source. The at least one coil is configured to generate an electromagnetic powering field emanating from the at least one coil. The at least one coil is further configured to radiate the electromagnetic powering field towards a volumetric zone for powering at least one receiver device located in the volumetric zone. The visualization unit is configured to provide a visual representation of a characteristic of the electromagnetic powering field radiated towards the volumetric zone.

### CROSS-REFERENCE TO RELATED APPLICATIONS

This is a continuation of International Patent Application No. PCT/EP2022/052013 filed on Jan. 28, 2022, the disclosure of which is hereby incorporated by reference in its entirety.

### TECHNICAL FIELD

The disclosure relates to the field of non-contact wireless power transmitters and controlling methods thereof that is suitable for creating and in some embodiments reconfiguring a wireless power transfer volume around it to wirelessly supply or charge devices and for communicating the wireless power transfer range to the user. In particular, the disclosure relates to a transmitter device having a visualization unit for wirelessly powering or charging at least one receiver device, a wireless powering system and a corresponding method. The disclosure particularly relates to wireless power transmitter device with visualization.

### BACKGROUND

Nowadays the number of battery-powered electronic devices is increasing rapidly because they provide freedom of movement and portability. Several methods for wireless power transmission (WPT) to recharge the battery of the electronic device without the use of a charging cable have been proposed in recent history.

Although great progress in the implementation of electromagnetic wireless power transfer has been made, there is currently no single solution that: could provide efficiency wireless power transmission with a high-degree of positioning freedom to the receivers, could simultaneously and efficiently charge several receivers, could charge receiver devices at extended transmission distances, could have the capabilities to reduce the wireless transfer of power to certain, unused locations, that is, to be able to segment the active volume, that could provide a more uniform magnetic field around the volume of the transmitter device, that could inform the user of the device the active wireless power transfer area, and let the user have control on the wireless power transfer profile according to a scenario.

### SUMMARY

This disclosure provides an efficient and flexible solution for a wireless power transfer with a high degree of positioning freedom to the receivers and that can inform the user about the active wireless power transfer area.

The foregoing and other objects are achieved by the features of the independent claims. Further implementation forms are apparent from the dependent claims, the description and the figures.

This disclosure introduces systems and methods to visualize the transmission range and active area of a wireless power transmitter device capable of generating a volumetric wireless power profile around it. Several kinds of transmitter devices are disclosed, one with a fixed wireless power transfer profile, one with an automatically reconfigurable wireless power transfer profile, and one with a power profile that can be configured upon a user input. For each of the transmitter systems, an operating method is also disclosed, wherein the method includes the display of the active wireless power transfer by means of active or passive components, among other steps.

In order to describe the disclosure in detail, the following terms and notations will be used.

In this disclosure, wireless power transfer, transmitter devices for wirelessly powering receiver devices and wireless powering systems are described.

Wireless power transfer is the transmission of electrical energy without the use of wires as a physical link. This technology uses a transmitter device capable of generating a time-varying electromagnetic field that causes a circulating electric field through a receiver device (or devices) based on the principle of electromagnetic induction. The receiver device (or devices) is (are) capable of being supplied directly from this circulating electric field or they convert it to a suitable power level to supply to an electrical load or battery connected to them.

Nowadays the number of battery-powered electronic devices is increasing rapidly because they provide freedom of movement and portability. These devices should be continuously recharged to ensure they function. Their charging frequency could be diminished by the use of a large battery, but these impact the overall cost of the electronic device, as well as their weight and size.

Charging of battery-powered electronic devices is usually done with the use of a wall charger and a dedicated cable that connects to an input port of the device to be charged to establish an electrical connection between the power supply and the power-hungry device. Some disadvantages of this charging mechanism are summarized as: a) The connector at this input port is susceptible to mechanical failure due to the connection/disconnection cycles required to charge the battery; b) Each battery-powered device comes with its dedicated cable and wall charger. These two components function sometimes exclusively with each device and are not interchangeable between devices. This increases the cost of the device and the electronic-waste generated by the non-functional wall chargers and cables; c) The production of waterproof devices becomes more challenging due to the higher cost associated with the enclosure required around the input port of the battery-powered electronic device; and d) The use of a cable restricts the mobility of the user according to the length of the charging cable.

In order to avoid these disadvantages, several methods for WPT to recharge the battery of the electronic device without the use of a charging cable have been proposed in recent history.

Commercial wireless power transfer systems have mainly been driven by two organizations, the Wireless Power Consortium and the AirFuel Alliance. The Wireless Power Consortium created the Qi Standard to wirelessly charge consumer electronic devices using magnetic induction from a base station, usually a thin mat-like object, containing one or more transmitter coils and a target device fitted with a receiving coil. Qi systems require close proximity of the transmitter and receiver devices, usually within a couple of millimeters to a couple of centimeters.

Wireless power transfer systems that function under the AirFuel Alliance principle use a resonant inductive coupling between the transmitter coil and the receiver coil to consequently charge the battery connected to the receiver device. The resonant coupling allows for the power to be transferred over greater distances and multiple receiver locations or orientations.

Devices, systems and methods are described to wirelessly supply to or charge the battery of electronic devices (e.g., smartphones, tablets, smart glasses, earphones, wearables, console remote controls, etc.), using wireless power transfer of the resonant type. The wireless power transfer devices described herein use resonant inductive coupling between the transmitter resonator(s) and the receiver resonator(s). In some aspects the wireless power transfer systems are capable of simultaneously supply to multiple receiver devices with severe angular misalignment with respect to the transmitter array and at any or many locations inside a charging volume extending outside of three-dimensional transmitter array. In other aspects, the methods disclosed herein allow to dynamically change the wireless power transfer volume around the transmitter device in response to user input or information coming from a receiver detection unit.

Due to their principle of operation, magnetic resonance coupling based systems provide multiple places on which the receiver device can receive wireless power from. However, since these systems are still limited by the evanescent behavior of the magnetic field extending out of the transmitter structure, the user cannot expect for the wireless power availability to extend unlimitedly. Therefore, this disclosure presents a method to communicate the user the physical range away from the transmitter structure in which the receiver device is enabled to receive the wireless power being sent by the wireless power transmitter to avoid overestimation of the operating range or avoiding placing foreign objects around the transmitter structure that might intervene with its correct operation.

The present disclosure presents wireless power transmitter devices that are able to supply wireless power to electrical devices without a battery, i.e., a lamp or another device of the sort or to electronic or electrical devices that have a battery in order to charge it like smartphones, tablets, smart-glasses, wireless earphones, wearable devices, console remote control, among other similar devices using wireless power transfer of the magnetic resonant kind. In some embodiments, the wireless power transmitters are capable of simultaneously supplying to multiple receiver devices with several angular misalignment and at many or any locations inside a charging volume extending outside of the transmitter device. In other aspects, the methods disclosed here allow to dynamically change the wireless power transfer volume around the transmitter device in response to user input or information coming from a receiver detection unit while being able to communicate the active side of the transmitter device to the user with the goal of demonstrating the transmission capabilities of the transmitter device to potentially achieve a more efficient wireless power transfer by avoiding excessive attenuation of the wireless power transfer profile.

According to a first aspect, the disclosure relates to a transmitter device for wirelessly powering at least one receiver device, the transmitter device comprising: a power source for providing electric power; at least one coil electrically connected to the power source, the at least one coil being configured to generate an electromagnetic powering field emanating from the at least one coil, wherein the at least one coil is further configured to radiate the electromagnetic powering field towards a volumetric zone for powering at least one receiver device located in the volumetric zone; and a visualization unit configured to provide a visual representation of a characteristic of the electromagnetic powering field radiated towards the volumetric zone.

A visualization unit as described in this disclosure can be implemented by a visualization circuit or any other optical means for visualizing the characteristic of the electromagnetic powering field.

Such a transmitter device can provide efficient wireless power transmission with a high degree of positioning freedom to one or more receivers. In particular, the transmitter device is able to simultaneously and efficiently charge several receivers, to charge receiver devices at extended transmission distances, to reduce the wireless transfer of power to certain, unused locations by segmenting the active volume. Besides, the transmitter device can provide a more uniform magnetic field around the volume of the transmitter device and can inform the user of the device about the active wireless power transfer area, and let the user have control on the wireless power transfer profile.

Providing the user of the wireless power transmitter devices with visual feedback may result in a more efficient wireless power transfer or charging procedure because the user will place the device to be charged or provided with wireless power within the wireless power transfer volume that the devices are able to produce.

This optical feedback is also useful because it avoids over-estimation of the wireless power transfer capabilities of the transmitter device that may lead to not providing wireless power at all.

All of the devices described in this disclosure are not only chargers but also transmitters. This means that one can have receiver devices without a battery to charge.

The idea behind the devices disclosed herein is to have a volumetric wireless power availability, i.e., the volumetric zone. This feature differentiates the disclosed devices from pad-like transmitters in which the wireless power transfer can only happen inside an area.

In an exemplary implementation of the transmitter device, the characteristic of the electromagnetic powering field comprises at least one of a transmission range, an active area, a wireless power profile, a radiation pattern, a flux line configuration and a beam density around the transmitter device.

This provides the advantage that the visualization unit is able to visualize different representations of the electromagnetic powering field. The user can flexibly request visualization of the above-mentioned different characteristics of the electromagnetic powering field.

In an exemplary implementation of the transmitter device, the characteristic of the electromagnetic powering field is based on at least one or a combination of: a magnitude, a phase and a frequency of the electric power provided by the power source, an impedance of the at least one coil of the transmitter device, and an impedance of a coil configuration of the at least one receiver device.

This provides the advantage that the relevant parameters of the power source and the coil structure can be efficiently adjusted. These parameters can then be easily changed or adjusted by the user based on the visualization of the resulting wireless power profile.

In an exemplary implementation of the transmitter device, the at least one coil is configured to generate the electromagnetic powering field as a volumetric wireless power profile and to direct the volumetric wireless power profile towards the volumetric zone.

As mentioned above, this provides the advantage that the transmitter device provides a volumetric wireless power availability, i.e., the volumetric zone, which differentiates the transmitter device from pad-like transmitters in which the wireless power transfer can only happen inside an area.

In an exemplary implementation of the transmitter device, the at least one volumetric wireless power profile is reconfigurable based on at least one or a combination of: information of the at least one receiver device, a user input, a change in operational parameters of the transmitter device, a change in operational parameters of the at least one receiver device.

This provides the advantage that the transmitter device can adjust its electromagnetic powering field based on a reconfiguration of the volumetric wireless power profile and thus adjust it to the current location of the receiver device(s) for optimal powering or charging.

In an exemplary implementation of the transmitter device, the transmitter device comprises a user interface for receiving the user input, wherein the user interface comprises at least one of or a combination of a press-button, a mechanical switch, a touch display or a communication interface with a remote user interface.

This provides the advantage that the user interface can be used to set the operating state of the transmitter device and that the user interface is easily implemented by different design options of the transmitter device.

In an exemplary implementation of the transmitter device, the information about the at least one receiver device comprises information about orientation, position and/or load changes of the at least one receiver device.

This provides the advantage that this information can be used for a precise adjustment of the volumetric zone towards the receiver device for optimally powering the receiver device.

In an exemplary implementation of the transmitter device, the operational parameters of the transmitter device comprise at least one or a combination of: a magnitude, a phase, a frequency of the electric power provided by the power source or an impedance of the at least one coil.

This provides the advantage that these operational parameters provide enough flexibility for accurately adjusting the volumetric zone towards the receiver device for optimally powering the receiver device.

In an exemplary implementation of the transmitter device, the transmitter device comprises: a receiver detection unit configured to detect at least one receiver device located in the volumetric zone; and a controller configured to enable powering the at least one receiver device detected by the receiver detection unit.

This provides the advantage that the transmitter device can operate in a power safe mode when no receiver device is detected in order to save energy. If a receiver device is detected, the transmitter device can efficiently power the detected receiver device without wasting energy.

A receiver detection unit according to this disclosure can be an electrical and/or optical circuit for detecting a receiver device located within a proximity of the transmitter device (i.e., within the volumetric zone) or for detecting a receiver device approaching the transmitter device (i.e., approaching the volumetric zone).

In an exemplary implementation of the transmitter device, the receiver detection unit is configured to detect at least one receiver device moved away from the volumetric zone; and the controller is configured to disable powering the at least one receiver device moved away from the volumetric zone.

This provides the advantage that the transmitter device can operate in an energy-efficient manner without wasting energy.

In an exemplary implementation of the transmitter device, the transmitter device comprises: a plurality of coils corresponding to the at least one coil; and a reconfigurable switching network coupled between the power source and the plurality of coils, the reconfigurable switching network comprising a plurality of switches, the plurality of switches being configured to interconnect coils from the plurality of coils according to a predetermined switching configuration to obtain a three-dimensional coil array, the three-dimensional coil array being configured to generate the electromagnetic powering field; wherein the three-dimensional coil array is further configured, based on the switching configuration of the plurality of switches, to radiate the electromagnetic powering field towards the volumetric zone.

Such a transmitter device can provide efficient wireless power transmission with a high degree of positioning freedom to one or more receivers. The electromagnetic powering field can be efficiently adjusted by using the switching network.

In an exemplary implementation of the transmitter device, the transmitter device comprises: at least one first coil corresponding to the at least one coil, the at least one first coil being electrically connected to the power source for generating a first electromagnetic field emanating from the at least one first coil; and a plurality of second coils arranged to form a three-dimensional coil array, the three-dimensional coil array being electromagnetically coupled via the first electromagnetic field to the at least one first coil, the three-dimensional coil array being configured to generate a second electromagnetic field emanating from the three-dimensional coil array; wherein the three-dimensional coil array is further configured to radiate the second electromagnetic field towards the volumetric zone.

Such a transmitter device can provide efficient wireless power transmission by adequate configuration of the three-dimensional coil-array. Configuration of the three-dimensional coil-array allows the transmitter device to segment the active volume.

In an exemplary implementation of the transmitter device, the visualization unit comprises at least one or a combination of light sources, light conducting elements and/or light scattering elements.

This provides the advantage that the visualization unit can be easily implemented. These light elements are an efficient means for visualizing the electromagnetic powering field.

In an exemplary implementation of the transmitter device, the transmitter device comprises: a top side, a bottom side opposing the top side and a plurality of side walls; wherein the visualization unit is configured to provide light strips on one or more side walls of the plurality of side walls, the side walls with the light strips being aligned towards the volumetric zone; or wherein the visualization unit is configured to provide light panels on the top side, the light panels being directed towards the volumetric zone.

This provides the advantage that the light strips or light panels can efficiently indicate the user the volumetric zone, i.e., the active zone where power can be transmitted.

In an exemplary implementation of the transmitter device, the transmitter device comprises: a box for housing the power source and the at least one coil, wherein the visualization unit comprises a physical template for positioning at a predefined position underneath the box, wherein a shape and profile of the physical template is configured to visualize the volumetric zone.

This provides the advantage that such a physical template can be easily implemented at low cost.

In an exemplary implementation of the transmitter device, the physical template comprises colored and/or patterned areas; and the visualization unit comprises light elements being configured to emit light in different spectra or to emit different light patterns, wherein the emitted spectra and/or emitted light patterns correspond to the areas of the physical template in order to visualize the volumetric zone.

This provides the advantage that such color or pattern information can efficiently inform the user about the volumetric zone.

In an exemplary implementation of the transmitter device, the transmitter device comprises a communication interface with a communication device, the communication interface being configured to transmit information for displaying a representation of the physical template on a display of the communication device.

This provides the advantage that the visual representation of the characteristic of the electromagnetic powering field can be remotely transferred, e.g., to a Smartphone of the user. Thus, neither light elements nor a template is required.

In an exemplary implementation of the transmitter device, the visualization unit comprises an optical circuit, the optical circuit comprising at least one or a combination of light sources, mask pattern slides and/or projection lens, wherein the optical circuit is configured to provide a projection of the volumetric zone on a surface onto which the transmitter device is placed.

Such an optical circuit provides an easy and efficient means for projecting the volumetric zone onto a surface.

According to a second aspect, the disclosure relates to a wireless powering system, comprising: a transmitter device according to the first aspect; and at least one receiver device configured to receive the electromagnetic powering field generated by the transmitter device upon movement into the volumetric zone for a wireless powering.

Such a wireless powering system can provide efficient wireless power transmission with a high degree of positioning freedom to one or more receivers. In particular, the wireless powering system is able to simultaneously and efficiently charge several receivers, to charge receiver devices at extended transmission distances, to reduce the wireless transfer of power to certain, unused locations, by segmenting the active volume. Besides, the wireless powering system can provide a more uniform magnetic field around the volume of the transmitter device and can inform the user of the device about the active wireless power transfer area, and let the user have control on the wireless power transfer profile.

According to a third aspect, the disclosure relates to a method for visualizing information about a volumetric zone of a transmitter device, the transmitter device radiating an electromagnetic powering field for wirelessly powering at least one receiver device, the method comprising: providing electric power by a power source; performing, by a receiver detection unit, a detection operation for detecting at least one receiver device inside a predefined range from the transmitter device; when a receiver device is detected inside the predefined range but outside the volumetric zone, providing, by a visualization unit, a visual representation of the volumetric zone towards which the transmitter device can radiate the electromagnetic powering field; when a receiver device is detected inside the volumetric zone, generating the electromagnetic powering field by at least one coil electrically connected to the power source, the electromagnetic powering field emanating from the at least one coil; radiating the electromagnetic powering field towards the volumetric zone by the at least one coil; and providing, by the visualization unit, a visual representation of the characteristic of the electromagnetic powering field radiated towards the receiver device.

The main idea behind the visualization unit is to aid the user to place the device in the supported range. The predefined range in which the receiver detection unit is capable of detecting a receiver includes and may surpass the volumetric zone towards which the transmitter device is capable of sending wireless power.

The receiver detection unit is capable of detecting a receiver in one, two or three dimensions.

According to a fourth aspect, the disclosure relates to a method for visualizing information about a volumetric zone of a transmitter device, the transmitter device radiating an electromagnetic powering field for wirelessly powering at least one receiver device, the method comprising: providing electric power by a power source; generating the electromagnetic powering field by at least one coil electrically connected to the power source, the electromagnetic powering field emanating from the at least one coil; radiating the electromagnetic powering field towards the volumetric zone by the at least one coil; and providing, by a visualization circuit, a visual representation of a characteristic of the electromagnetic powering field radiated towards the volumetric zone.

Such a method provides the same advantages as the transmitter device according to the first aspect and the wireless powering system according to the second aspect.

According to a fifth aspect, the disclosure relates to a wireless power transmitter device comprising; a power supply configured to supply power wirelessly to at least one receiver device within a defined volume around the wireless power transmitter device; a receiver detection unit capable of detecting at least one receiver device configured to receive the wireless power coming from the wireless power transfer device; a visualization unit that informs the user about the active wireless power transfer volume around the transmitter device in which an enabled receiver device can obtain wireless power from the wireless power transmitter device; wherein the visualization unit may comprise active and or passive signalization elements; a control unit for data processing storage and actionable measures; wherein the wireless power transmitter device is operated to wirelessly power or charge electric or electronic device(s) by providing the generated wireless power to the at least one receiver device configured to receive the wireless power.

In an exemplary implementation of the wireless power transmitter device, the visualization unit comprises passive components such as a predefined physical template with the dimension and profile of the expected wireless power availability volume of a wireless power transmitter device whose wireless power profile is fixed; wherein the at least one receiver device can be supplied with wireless power, as long as it is somewhere in the volume around the transmitter inside the template.

In an exemplary implementation of the wireless power transmitter device, the wireless power supply comprises at least one transmitter coil electrically connected to a power source.

In an exemplary implementation of the wireless power transmitter device, the wireless power supply comprises at least one coil electrically connected to the power supply and a 3-dimensional arrangement of coil magnetically coupled to the at least one coil electrically connected to the power supply.

In an exemplary implementation of the wireless power transmitter device, the receiver detection unit detects a change in the reflected impedance to the transmitter device according to coupling of load changes of the at least one receiver.

In an exemplary implementation of the wireless power transmitter device, the wireless power transmitter device further comprises a communications unit functioning at another frequency than the frequency of the wireless power transmission.

In an exemplary implementation of the wireless power transmitter device, the wireless power transfer device further comprises a user interface.

In an exemplary implementation of the wireless power transmitter device, the visualization unit comprises passive and active elements such as light sources, liquid crystal displays, light conducting elements, light scattering elements onto the device; wherein the visualization unit is operated to provide a virtual representation of the expected wireless power volume of the wireless power transmitter device by illumination.

In an exemplary implementation of the wireless power transmitter device, the visualization unit comprises active and passive elements such as light sources, mask pattern slides, at least one projection lens; wherein the visualization unit is operated to provide a visual representation of the wireless power availability around the transmitter device; wherein the shape of the light being reflected on the surface onto which the transmitter device is placed significantly matches the expected wireless power availability volume of the wireless power transmitter device.

In an exemplary implementation of the wireless power transmitter device, the visualization unit is a virtual representation of the wireless power transfer profile on a smartphone.

According to a sixth aspect, the disclosure relates to a method of controlling and operating a wireless power transmitter device according to the fifth aspect, comprising the steps of: Starting operation of the wireless power transmitter device; If a receiver device configured to receive the wireless power from the wireless power transmitter device is detected by the receiver detection unit; the control unit assesses if the at least one receiver device is inside the volume in which the wireless power transmitter device can supply wireless power to the receiver device; when supplying wireless power is possible, the control unit operates the wireless power transmitter device to initiate a wireless power transfer protocol to the receiver device and operate the visualization unit to inform the user about the active wireless power transfer volume around the transmitter device; when supplying wireless power is not possible, operate the visualization unit to call for the user's attention by, for instance, performing light blinking or dimming effects to inform the user about the active wireless power transfer volume around the transmitter device in which the transmitter device is capable of providing wireless power to the receiver device; and continue with the loop while the device is on.

In an exemplary implementation of the wireless power transmitter device, the power supply unit is reconfigurable; wherein the wireless power transmitter device is operated by the control unit to wirelessly supply or charge electric or electronic devices by automatically reconfiguring the profile of the generated wireless power transfer volume depending on the information obtained by the receiver detection unit to provide the generated wireless power to the at least one receiver device configured to receive the wireless power coming from the transmitter device.

In an exemplary implementation of the wireless power transmitter device, the wireless power supply comprises at least one transmitter coil electrically connected to a power source; wherein the energy transfer from the transmitter device to the receiver device can be adjusted by inducing a change in magnitude, phase, frequency of combination of thereof to the power source or by inducing a change to the equivalent impedance of the coil(s) in the transmitter device.

In an exemplary implementation of the wireless power transmitter device, the wireless power supply comprises at least one coil electrically connected to the power supply and a 3-dimensional arrangement of coil magnetically coupled to the at least one coil electrically connected to the power supply and structured to produce an electromagnetic field that emanates from the 3-dimensional coil array; wherein the profile of the wireless power transfer volume can be adjusted by operating the control unit to induce a change in the equivalent impedance of the coils in the 3-dimensional array or the one or more coils electrically connected to the power source or by changing the electromagnetic coupling between the coils forming the 3-dimensional array and the at least one coil electrically connected to the power supply.

In an exemplary implementation of the wireless power transmitter device, the wireless power supply comprises a power source; at least two coils connectable at each end and forming a 3-dimensional array and an operable switching network with 2 input terminals that creates a reconfigurable series electrical connection between the power source and at least one of the coils to produce a closed electrical circuit for electrons to flow through and that generates an electromagnetic field that emanates from the 3-dimensional array; wherein the profile of the wireless power transfer volume can be adjusted by operating the control unit to operate the connections of the switching network.

In an exemplary implementation of the wireless power transmitter device, the receiver detection unit detects a change in the reflected impedance to the transmitter device according to coupling or load changes of the at least one receiver device.

In an exemplary implementation of the wireless power transmitter device, the wireless power transmitter device further comprises a communications unit functioning at another frequency than the frequency of the wireless power transmission.

In an exemplary implementation of the wireless power transmitter device, the visualization unit comprises light sources of different colors and passive displaying elements such as pre-defined physical templates with colored patterns and profiles whose colors significantly match the color of the light source and whose profiles and dimensions significantly match the active wireless power volume of the wireless power transmitter device; wherein the control unit is operated to reconfigure the wireless power volume around the wireless power transmitter device and the corresponding light source.

In an exemplary implementation of the wireless power transmitter device, the visualization unit comprises passive and active elements such as light sources, liquid crystal displays, light conducting elements, light scattering elements onto the device; wherein the visualization unit is operated to provide a virtual representation of the active wireless power direction of the wireless power transmitter device by illumination.

In an exemplary implementation of the wireless power transmitter device, the visualization unit is a virtual representation on a smartphone.

In an exemplary implementation of the wireless power transmitter device, the visualization unit comprises active and passive elements such as light sources, mask pattern slides, at least one projection lens; wherein the visualization unit is operated to provide a visual representation of the active wireless power volume of the transmitter device; wherein the shape of the light being reflected on the surface onto which the transmitter device is placed indicates the active wireless power volume of the wireless power transmitter device.

According to a seventh aspect, the disclosure relates to a method of controlling and operating a wireless power transfer device according to the fifth aspect, comprising the steps of: starting operation of the wireless power transmitter device; if a receiver device configured to receive the wireless power from the wireless power transmitter device is detected by the receiver detection unit; the control unit assesses if the at least one receiver device is inside the volume in which the wireless power transmitter device can supply wireless power to the receiver device; when supplying wireless power is possible, the control unit determines which working mode of operating the wireless power supply is the most suitable according to the information obtained from the receiver detection unit, reconfigure the transmitter device to operate in such mode and initiate a wireless power transfer protocol to the receiver device and operate the visualization unit to inform the user about the active wireless power transfer volume around the transmitter device; when supplying wireless power is not possible, operate the visualization unit to call for the user's attention by, for instance, performing light blinking or dimming effects to inform the user about the active wireless power transfer volume around the transmitter device in which the transmitter device is capable of providing wireless power to the receiver device; continue with the loop while the device is on.

In an exemplary implementation of the wireless power transmitter device, the wireless power transfer device comprises a user interface, wherein the wireless power transmitter device is operated by the user and the control unit to wirelessly power or charge electric or electronic device(s) by reconfiguring the profile of the generated wireless power depending on the input obtained by the user, to provide the generated wireless power to at least one receiver device configured to receive the wireless power inside the active volume through the selection.

According to an eighth aspect, the disclosure relates to a method of operating the wireless power transmitter device, comprising the steps of: starting operation of the wireless power transmitter device; configure the wireless power transmitter device to work in a default operation mode; if a receiver device configured to receive the wireless power from the wireless power transmitter device is detected by the receiver detection unit; the control unit assesses if the at least one receiver device is inside the volume in which the wireless power transmitter device can supply wireless power to the receiver device; when supplying wireless power is possible, the control unit determines which working mode of operating the wireless power supply is the most suitable according to the information obtained from the receiver detection unit, reconfigure the transmitter device to operate in such mode and initiate a wireless power transfer protocol to the receiver device and operate the visualization unit to inform the user about the active wireless power transfer volume around the transmitter device; when supplying wireless power is not possible, operate the visualization unit to call for the user's attention by, for instance, performing light blinking or dimming effects to inform the user about the active wireless power transfer volume around the transmitter device in which the transmitter device is capable of providing wireless power to the receiver device; continue with the loop while the device is on; if and when a different operation mode is selected by the user through the user interface unit, reconfigure the wireless power transmitter device to operate in such mode.

In an exemplary implementation of the wireless power transmitter device, the power supply capable of generating wireless power further comprises an electrical resonant circuit.

In an exemplary implementation of the wireless power transmitter device, the inductive element can have a circular or polygonal shape, such as triangular, square, rectangular, pentagonal, hexagonal, etc.

According to a tenth aspect, the disclosure relates to a computer program product including computer executable code or computer executable instructions that, when executed, causes at least one computer to execute the methods according to any of the preceding aspects described above.

The computer program product may run on a transmitter device as described above or on any controller or processor performing wireless power transfer.

According to an eleventh aspect, the disclosure relates to a computer-readable medium, storing instructions that, when executed by a computer, cause the computer to execute the methods according to any of the preceding aspects described above. Such a computer readable medium may be a non-transient readable storage medium. The instructions stored on the computer-readable medium may be executed by a controller or a processor, e.g., by a transmitter device described above.

### BRIEF DESCRIPTION OF THE DRAWINGS

Further embodiments of the disclosure will be described with respect to the following figures, in which:

FIG. 1 shows a schematic diagram of a wireless power transfer system 100 with a wireless transmitter device 101 having a visualization unit 105 according to the disclosure;

FIGS. 2A-2C show schematic diagrams illustrating three embodiments 200a, 200b, 200c of the wireless power supplies 102 of the wireless transmitter device 101 shown in FIG. 1;

FIG. 3 shows a block diagram illustrating an embodiment of a wireless power supply 102 of the wireless transmitter device 101 shown in FIG. 1 and an embodiment of the wireless receiver device 108 shown in FIG. 1;

FIG. 4 shows a block diagram illustrating an embodiment of the wireless power transfer system 100 shown in FIG. 1;

FIGS. 5A-5B show schematic diagrams illustrating two embodiments of a visualization unit according to the disclosure;

FIG. 6 shows schematic diagrams illustrating other embodiments of visualization units according to the disclosure;

FIG. 7 shows a schematic diagram illustrating another embodiment of a visualization unit according to the disclosure;

FIG. 8 shows a schematic diagram illustrating an embodiment of a wireless transmitter device 101 with a user interface according to the disclosure;

FIG. 9 shows a flow chart illustrating an exemplary operation of a wireless power transmitter device 101 according to the disclosure;

FIG. 10 shows a flow chart illustrating another exemplary operation of a wireless power transmitter device 101 according to the disclosure;

FIG. 11 shows a flow chart illustrating another exemplary operation of a wireless power transmitter device 101 according to the disclosure;

FIG. 12 shows a schematic diagram illustrating a method 1200 for visualizing information about a volumetric zone of a transmitter device 101 according to the disclosure; and

FIG. 13 shows a schematic diagram illustrating a wireless transmitter device 101 according to the disclosure with detection area 1310 and charging area or volumetric zone 1320.

### DETAILED DESCRIPTION OF EMBODIMENTS

In the following detailed description, reference is made to the accompanying drawings, which form a part thereof, and in which is shown by way of illustration specific aspects in which the disclosure may be practiced. It is understood that other aspects may be utilized and structural or logical changes may be made without departing from the scope of the disclosure. The following detailed description, therefore, is not to be taken in a limiting sense, and the scope of the disclosure is defined by the appended claims.

It is understood that comments made in connection with a described method may also hold true for a corresponding device or system configured to perform the method and vice versa. For example, if a specific method step is described, a corresponding device may include a unit to perform the described method step, even if such unit is not explicitly described or illustrated in the figures. Further, it is understood that the features of the various exemplary aspects described herein may be combined with each other, unless specifically noted otherwise.

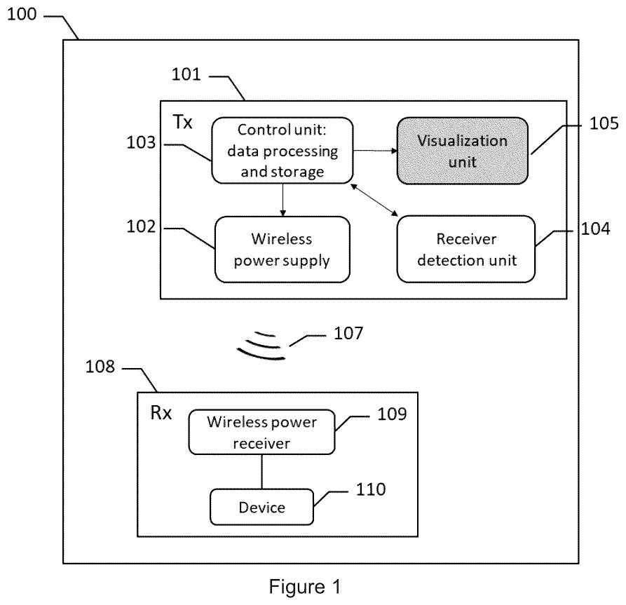

FIG. 1 shows a schematic diagram of a wireless power transfer system 100 with a wireless transmitter device 101 having a visualization unit 105 according to the disclosure.

The wireless powering system 100 comprises a transmitter device 101 and one or more receiver devices 108 which are configured to receive an electromagnetic powering field 107 generated by the transmitter device 101 upon movement into a volumetric zone for a wireless powering. The volumetric zone specifies a volume around the transmitter device 101 in which powering of the receiver device 108 can be performed due to a sufficient strength of the second electromagnetic field 107 radiated by the transmitter device 101.

The transmitter device 101 can be used for wirelessly powering at least one receiver device 108. The transmitter device 101 comprises a wireless power supply 102, for providing wireless power to the receiver device 108.

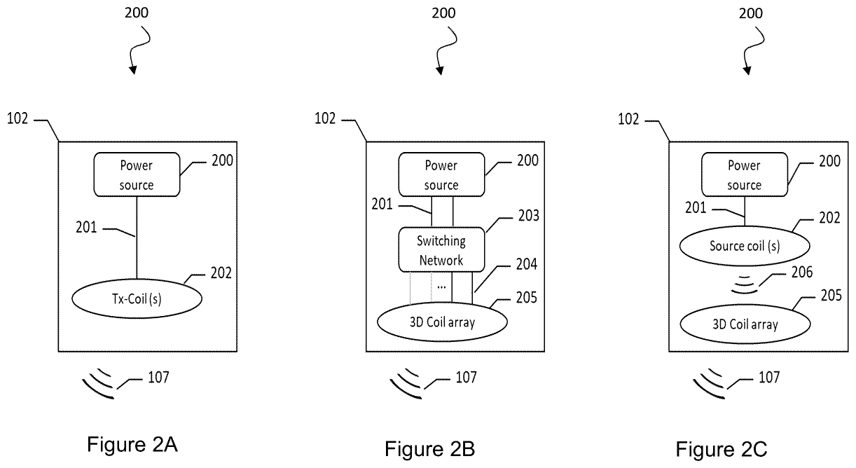

The transmitter device 101 comprises a power source 200 for providing electric power, at least one coil 202 electrically connected to the power source 200, e.g., as shown in FIGS. 2A-2C. The at least one coil 202 is configured to generate an electromagnetic powering field 107 emanating from the at least one coil 202. The at least one coil 202 is further configured to radiate the electromagnetic powering field 107 towards a volumetric zone for powering at least one receiver device located in the volumetric zone.

The transmitter device 101 comprises a visualization unit 105 configured to provide a visual representation of a characteristic of the electromagnetic powering field radiated towards the volumetric zone.

A visualization unit as described in this disclosure can be implemented by a visualization circuit or any other optical means for visualizing the characteristic of the electromagnetic powering field.

The transmitter device 101 may further comprise a control unit 103 for data processing and storage and a receiver detection unit 104 as described below.

The characteristic of the electromagnetic powering field may comprise at least one of a transmission range, an active area, a wireless power profile, a radiation pattern, a flux line configuration and a beam density around the transmitter device 101.

The characteristic of the electromagnetic powering field can be based on at least one or a combination of: a magnitude, a phase and a frequency of the electric power provided by the power source 200, e.g., as shown in FIGS. 2A-2C, and an impedance of the at least one coil 202 of the transmitter device 101.

The at least one coil 202 may be configured to generate the electromagnetic powering field 107 as a volumetric wireless power profile and to direct the volumetric wireless power profile towards the volumetric zone.

The at least one volumetric wireless power profile may be reconfigurable based on at least one or a combination of: information of the at least one receiver device 108, a user input, a change in operational parameters of the transmitter device 101, a change in operational parameters of the at least one receiver device 108.

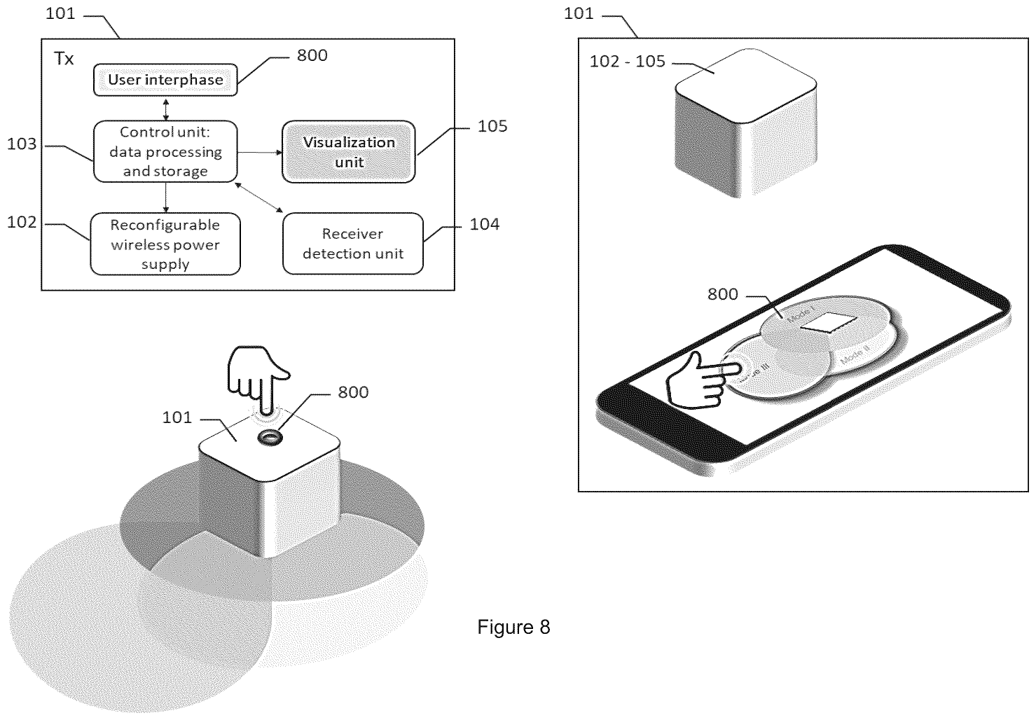

The transmitter device 101 may comprise: a user interface 800 for receiving the user input, e.g., as shown in FIG. 8. The user interface 800 may comprise at least one of or a combination of a press-button, a mechanical switch, a touch display or a communication interface with a remote user interface.

The information about the at least one receiver device 108 may comprise information about orientation, position and/or load changes of the at least one receiver device 108.

The operational parameters of the transmitter device 101 may comprise at least one or a combination of: a magnitude, a phase, a frequency of the electric power provided by the power source 200 or an impedance of the at least one coil 202.

The transmitter device 101 may comprise a receiver detection unit 104 configured to detect at least one receiver device 108 located within a predefined range 1310.

The transmitter device 101 may comprise a controller 103 configured to enable powering the at least one receiver device 108 detected by the receiver detection unit 104.

A receiver detection unit according to this disclosure can be an electrical and/or optical circuit for detecting a receiver device located within a proximity of the transmitter device (i.e., within the volumetric zone) or for detecting a receiver device approaching the transmitter device (i.e., approaching the volumetric zone).

The receiver detection unit 104 may be configured to detect at least one receiver device 108 moved away from the volumetric zone. The controller 103 may be configured to disable powering the at least one receiver device 108 moved away from the volumetric zone.

The transmitter device 101 may comprise: a plurality of coils corresponding to the at least one coil 202; and a reconfigurable switching network 203, e.g. as shown in FIG. 2B, coupled between the power source 200 and the plurality of coils, the switching network 203 comprising a plurality of switches, the plurality of switches being configured to interconnect coils from the plurality of coils according to a predetermined switching configuration to obtain a three-dimensional coil array 205, the three-dimensional coil array 205 being configured to generate the electromagnetic powering field 107. The three-dimensional coil array 205 may be further configured, based on the switching configuration of the plurality of switches, to radiate the electromagnetic powering field 107 towards the volumetric zone.

The transmitter device 101 may comprise: at least one first coil 202 corresponding to the at least one coil 202, the at least one first coil 202 being electrically connected to the power source 200 for generating a first electromagnetic field 206 emanating from the at least one first coil 202, e.g., as shown in FIG. 2C; and a plurality of second coils arranged to form a three-dimensional coil array 205.

The three-dimensional coil array 205 may be electromagnetically coupled via the first electromagnetic field 206 to the at least one first coil 202. The three-dimensional coil array 205 may be configured to generate a second electromagnetic field 107 emanating from the three-dimensional coil array 205, e.g., as shown in FIG. 2C. The three-dimensional coil array 205 may further be configured to radiate the second electromagnetic field 107 towards the volumetric zone.

The visualization unit 105 may comprise at least one or a combination of light sources, light conducting elements and/or light scattering elements.

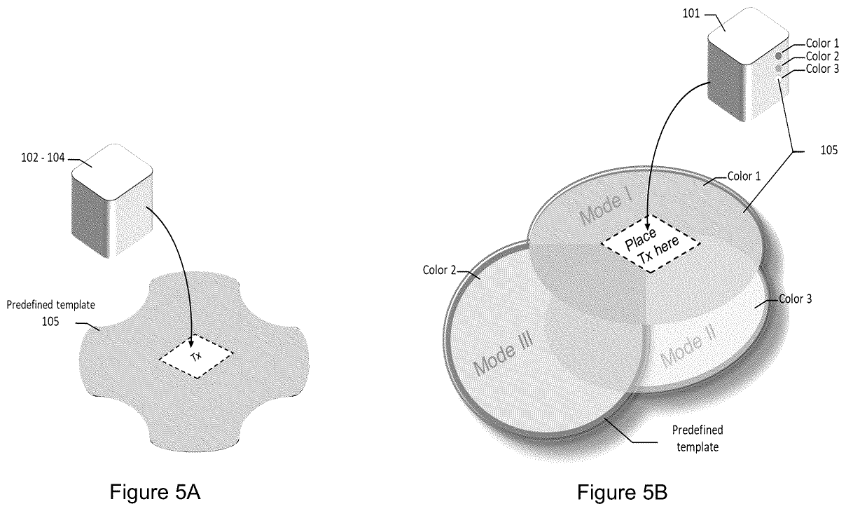

The transmitter device 101 may comprise a box for housing the power source 200 and the at least one coil 202. The visualization unit 105 may comprise a physical template for positioning at a predefined position underneath the box, e.g., as shown in FIGS. 5A-5B. A shape and profile of the physical template may be configured to visualize the volumetric zone.

The physical template may comprise colored and/or patterned areas, e.g., as shown in FIGS. 5A-5B. The visualization unit 105 may comprise light elements being configured to emit light in different spectra or to emit different light patterns. The emitted spectra and/or emitted light patterns correspond to the areas of the physical template in order to visualize the volumetric zone.

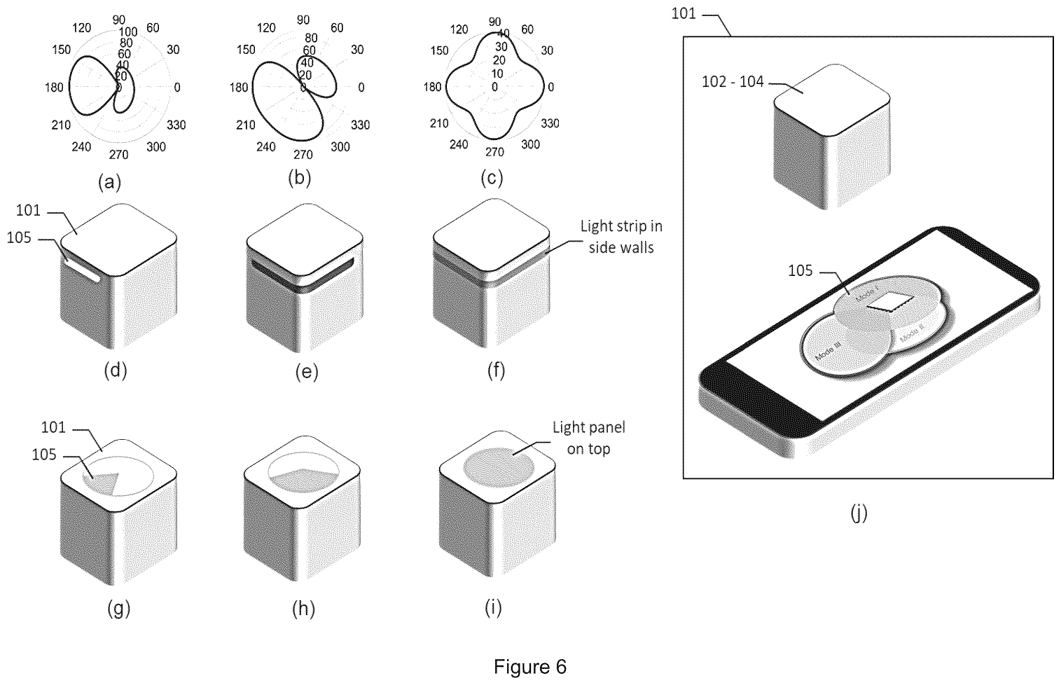

The transmitter device 101 may comprise: a top side, a bottom side opposing the top side and a plurality of side walls. The visualization unit 105 may be configured to provide light strips on one or more side walls of the plurality of side walls, the side walls with the light strips being aligned towards the volumetric zone, e.g., as shown in FIG. 6. Alternatively, the visualization unit 105 may be configured to provide light panels on the top side, the light panels being directed towards the volumetric zone.

The transmitter device 101 may comprise a communication interface with a communication device, e.g., as shown in FIG. 6(j). The communication interface may be configured to transmit information for displaying a representation of the physical template on a display of the communication device.

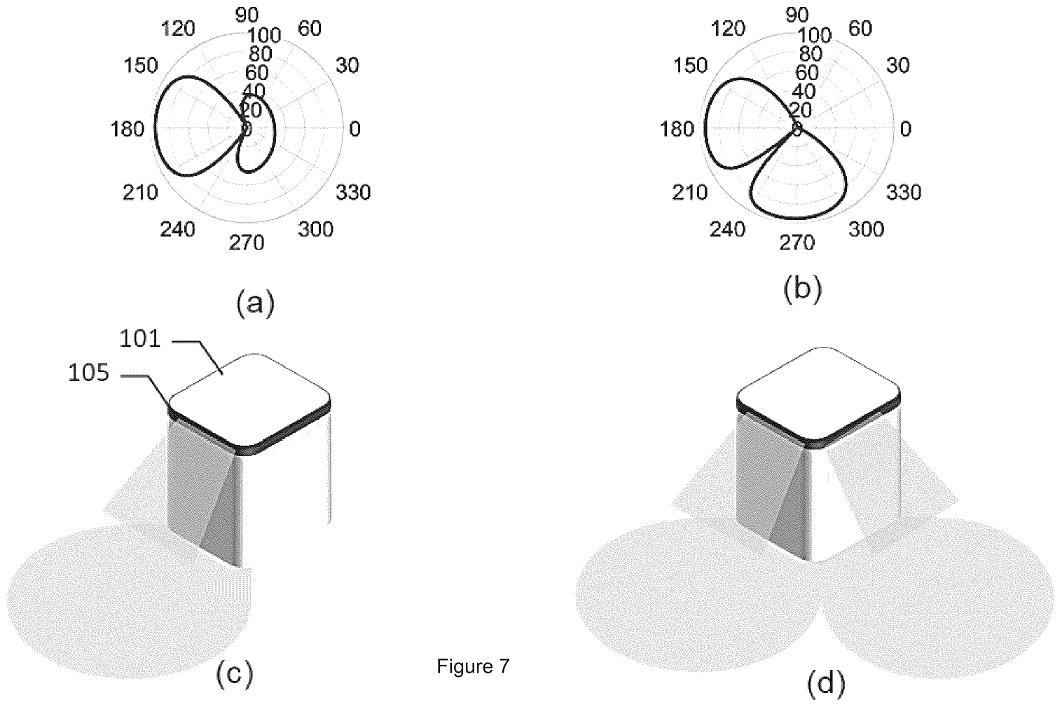

The visualization unit 105 may comprise an optical circuit which may comprise at least one or a combination of light sources, mask pattern slides and/or projection lens. The optical circuit may be configured to provide a projection of the volumetric zone on a surface onto which the transmitter device 101 is placed, e.g., as shown in FIG. 7.

The transmitter device 101 may be configured to perform the following method: a method for visualizing information about a volumetric zone of a transmitter device 101 which radiates an electromagnetic powering field 107 for wirelessly powering at least one receiver device 108. The method comprises: providing electric power by a power source 200, e.g., as shown in FIGS. 2A-2C. The method comprises: generating the electromagnetic powering field 107 by at least one coil 202 electrically connected to the power source 200, the electromagnetic powering field 107 emanating from the at least one coil 202. The method comprises: radiating the electromagnetic powering field 107 towards the volumetric zone by the at least one coil 202. The method comprises: providing, by a visualization circuit, a visual representation of a characteristic of the electromagnetic powering field radiated towards the volumetric zone.

The wireless power transmitter device 101 is able to supply wireless power to electrical devices without a battery, i.e., a lamp or another device of the sort or to electronic or electrical devices that have a battery in order to charge it like smartphones, tablets, smart-glasses, wireless earphones, wearable devices, console remote control, among other similar devices using wireless power transfer of the magnetic resonant kind. In some embodiments, the wireless power transmitter device 101 is capable of simultaneously supplying to multiple receiver devices with several angular misalignment and at many or any locations inside a charging volume extending outside of the transmitter device.

In other aspects, the wireless power transmitter device 101 may be configured to dynamically change the wireless power transfer volume, i.e., the volumetric zone, around the transmitter device 101 in response to user input or information coming from a receiver detection unit 104 while being able to communicate the active side of the transmitter device 101 to the user with the goal of demonstrating the transmission capabilities of the transmitter device 101 to potentially achieve a more efficient wireless power transfer by avoiding excessive attenuation of the wireless power transfer profile.

In the following, a specific implementation of the wireless power transfer system 100 is described.

The wireless power transfer system 100 may be composed by a wireless power transmitter device 101 and at least one receiver device 108 able to receive the wireless power coming from the transmitter device. The wireless power transmitter device 101 may comprise several modules like a wireless power supply 102 configured to supply power wirelessly to at least one receiver device 108 within a volume around the wireless power transmitter device; a receiver detection unit 104 capable of detecting valid receiver(s) device(s) within a volume around the wireless power transmitter device that may be the same volume as the available wireless power volume or different; a visualization unit 105 that informs the user about the active area where at least one receiver device is being or can be supplied with wireless power or be charged by receiving wireless power. The visualization unit 105 may comprise active or passive elements. The wireless power transmitter device 101 may comprise a control unit 103 for data processing and storage. The wireless power transmitter device 101 may be operated to wirelessly power or charge electric or electronic device(s) by providing the generated wireless power 107 to the at least one receiver device 108 configured to receive the wireless power.

The transmitter device 101 can have a single transmitter coil 202 or an arrangement of coils 205, e.g., as shown in FIGS. 2A-2C, acting as the inductive element(s) of an inductive-capacitive resonator that when being excited to a time-varying voltage or current source(s) produces a time varying electromagnetic field 107 that in turn causes a circulating electric field through a receiver device 108 or a plurality of receiver devices using the principle of magnetic resonant induction.

Providing the user of the wireless power transmitter devices with visual feedback may result in a more efficient wireless power transfer or charging procedure because the user will place the device to be charged or provided with wireless power within the wireless power transfer volume that the devices are able to produce.

This optical feedback is also useful because it avoids over-estimation of the wireless power transfer capabilities of the transmitter device that may lead to not providing wireless power at all.

The visual feedback of the active volume around the transmitter device is useful in environments in which foreign objects that might affect the correct functioning of the transmitter device are placed around it because the objects are metallic or ferromagnetic.

The disclosed visualization unit can be implemented in a simple manner because passive components may be used as exemplified in FIG. 5A.

The disclosed visualization units and operation methods of the disclosed wireless power transmitter devices can be independent of the user input.

The user input can be used to set the operation mode of the transmitters which is also useful when the surroundings contain foreign objects that might affect its correction functioning because the objects may be metallic or ferromagnetic.

FIGS. 2A-2C show schematic diagrams illustrating three embodiments 200a, 200b, 200c of the wireless power supplies 102 of the wireless transmitter device 101 shown in FIG. 1. These embodiments 200a, 200b, 200c are able to produce a wireless power volume, also called volumetric zone, around the transmitter coils or coil arrays.

FIG. 2A shows the first embodiment 200a of a wireless power supply comprising at least one transmitter coil 202 electrically connected to a power source 200. The energy transfer from the transmitter device 101 to the receiver device 108 can be adjusted by inducing a change in magnitude, phase, frequency (combinations) to the power source 200 or by inducing a change to the equivalent impedance of the coil(s) either in the transmitter or on the receiver sides to wirelessly power or charge electric or electronic device(s) 108.

FIG. 2B shows the second embodiment 200b of a wireless power supply comprising a power source 200, at least two coils 205 connectable at each end 204 and forming a 3-dimensional array 205 and an operable switching network 203 with 2 input terminals 201 that creates a reconfigurable series electrical connection between the power source and at least one of the coils to produce a closed electrical circuit for electrons to flow through and that generates an electromagnetic field 107 that emanates from the 3D array 205 to wirelessly power or charge electric or electronic device(s) 108.

FIG. 2C shows the third embodiment 200c of a wireless power supply comprising one or more coils 202 electrically connected 201 to a time-varying power source 200. The transmitter also comprises a 3D arrangement of coils 205 magnetically coupled 206 to the one or more coils 202 electrically coupled to the power source and structured to produce an electromagnetic field 107 that emanates from the 3-dimensional coil array 205 to wirelessly power or charge electric or electronic device(s) 108. The energy transfer from the transmitter device 101 to the receiver device 108 can be adjusted by inducing a change in the equivalent impedance of the coils in the 3D array 205 and the one or more coils 202 electrically connected to the power source 200.

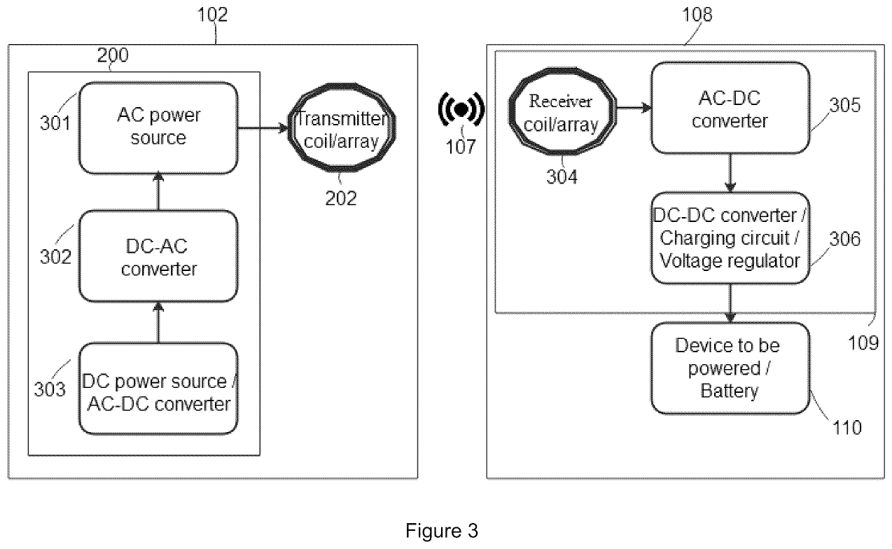

FIG. 3 shows a block diagram illustrating an embodiment of a wireless power supply 102 of the wireless transmitter device 101 shown in FIG. 1 and an embodiment of the wireless receiver device 108 shown in FIG. 1.

As depicted in FIG. 3, the wireless power supply 102 may comprise a power source 200 coupled to a transmitter coil/array 202. The power source 200 may comprise an alternating current (AC) power source 301, a DC-AC converter 302 and a direct current (DC) power source and/or AC-DC converter 303.

The power source 200 may inject or supply energy to the resonators of the transmitter device 101. For example, the power source 200 may inject current to the transmitter coils 202 or 205 via a direct electrical connection to the AC power source 301 at a certain excitation frequency and/or exciting a circulating electric field in the resonators inductively, such as resonance and/or inductive power transfer 206.

In some implementations, the AC power source 301 of the transmitter device 101 may be connected to the output of a DC to AC converter 302 in order to extract the required power for its function from a DC power source 303, such as a battery in the transmitter device 101. In some other implementations the transmitter device 101 may extract the required power for its function from an AC-DC converter 303, such as a circuit that converts the AC power of the line into a DC power.

The receiver device 108 may have a single coil or an arrangement of coils 304 acting as the inductive element(s) of an inductive-capacitive resonator(s). In some implementations, the receiver device 108 may be connected to an AC-DC converter 305, for example a rectifier that converts the AC to a DC if the device to be powered by the specific application requires DC, such as the case of delivering DC power to an electronic device. In some other implementations, the receiver device 108 may comprise a circuit 306 to convert a DC power level to another DC power level, such as a DC-DC converter or a charging circuit used to regulate the power delivered to the battery of the electronic device 110 that is being supplied to or even a voltage regulator that ensures a certain voltage level at the input of the electronic device.

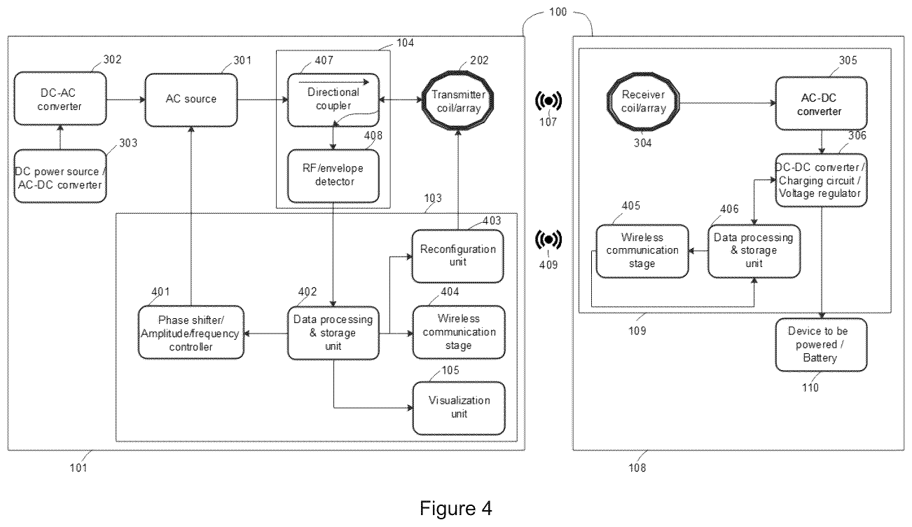

FIG. 4 shows a block diagram illustrating an embodiment of the wireless power transfer system 100 shown in FIG. 1.

FIG. 4 shows a more detailed embodiment of the wireless power transfer system 100 shown in FIG. 1 featuring a wireless power transmitter 101 with the possibility of generating a wireless charging volume, also called volumetric zone, around them as well as to adjust the wireless power transfer to the at least one receiver 108.

The wireless power transmitter 101 can adjust the wireless power transfer by the use of the control unit 103, for example, by operating the controller 401 that changes the characteristics of the AC source 301 like changes in the magnitude, phase or frequency or combinations of thereof or by operating the reconfiguration unit 403 to reconfigure the series electrical connection between the power source and at least one of the coils to produce a closed electrical circuit for electrons to flow through and that generates an electromagnetic field 107 that emanates from the 3-dimensional array 205 to wirelessly power or charge electric or electronic device(s) 108 or by operating the reconfiguration unit 403 to perform a change in the equivalent impedance of the coils in the 3-dimensional array 205 and the one or more coils 202 electrically connected to the power source 200.

These possible changes can be achieved with the use of a receiver detection unit 104 that is directly affected by a possible change in the coupling conditions of the at least one receiver 108 with respect to the transmitter 101. For example, when a receiver device is moved from a previous location to a new location, because of the electromagnetic coupling 107 that exists between the receiver coil or coil array 304 and the transmitter coil or coil array 202, there will be a change reflected on the transmitter coil or coil array 202 by a change in the impedance with which the receiver device 108 loads the wireless power transmitter 101.

For example, in the case where the receiver 108 is composed by one single resonator with a total impedance of Z_{Rx} and that it is connected to a load R_{L} in series, the impedance “reflected” Z_{reflected} to each coil of the transmitter array is given by the following relation:

$${Z}_{reflected} = \frac{{ω}^{2} {M}_{Rx \to Tx}^{2}}{{Z}_{Rx} + {R}_{L}} \qquad ( 1 )$$

where ω is the angular operation frequency and M_{Rx→Tx} is the mutual inductance between the single receiver resonator and a given transmitter resonator. In this FIG. 4, the receiver detection unit 104 is embodied by a bi-directional coupler 407 connected as a reflectometer and that in turn is connected to an RF detector circuit 408.

The power detection unit may comprise other voltage/current/impedance/power sensitive circuit that will be directly affected by the above relation (1) for a changing coupling condition of the receiver(s). Note that even when the receiver device 108 did not undergo a change in position or orientation, relation (1) can still be affected when a change in the load of the receiver device is present. This can be, for example, a change in the charging status of a battery attached to the device 110.

The receiver detection unit in this FIG. 4 may be connected to a data processing and storage unit 402 that may be accomplished with a central processing unit, a micro-computer or a microcontroller in charge of sampling and processing the analogue voltage coming out of the receiver detection unit 104 to effectively operate the AC source controller 401 that sets the operating conditions of the AC source 301 that excites the transmitter coil or coil array or the operating conditions of the reconfiguration unit 403 through the receiver detection unit 104.

The data processing/storage unit 402 may also be affected by the information coming from a possible wireless communication stage 404 in the transmitter device 101 which is capable to wirelessly communicate to the wireless communication stage 405 in the receiver device 108 through electromagnetic waves 409.

The two wireless communication stages 404 and 405 may exchange information via two distinct transducers compatible with, but not limited to Bluetooth, BLE, ZigBee, WiFi, WLAN, Thread, cellular communications like 2G/3G/4G/5G/Long-Term Evolution (LTE), NB-IoT, near-field communication (NFC), radio frequency identification (RFID), WirelessHART, among others.

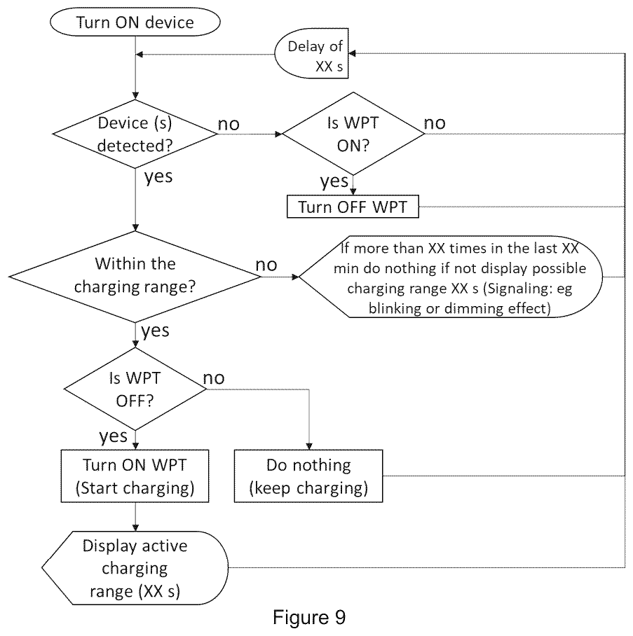

On the receiver device 108, the wireless communication 405 stage may aid in controlling a charging circuit 306 via another data processing and storage unit 406 that may be present in the receiver device 406. There can be a script running inside the data processing and storage unit 402 capable of gathering the relevant information related to the coupling conditions of the receiver(s) and other information like the level of the charge of the battery in the receiver device whenever one is present or setting up a chain of events, e.g., according to the methods disclosed below with respect to FIGS. 9 to 11.

In order to compensate for a changing coupling or load conditions of the at least one receiver device 108, the control unit 103 may operate the controller 401 that changes the characteristics of the AC source 301 like changes in the magnitude, phase or frequency or combinations of thereof.

A phase shifter can be used to change the transmission phase angle of an input signal while leaving the amplitude of the input signal being affected by the insertion loss of the component. The input signal will be shifted in phase at the output based on the configuration of the phase shifter. The phase shifter may be digital, analogue or mechanical. In another implementation of the systems, the change in the phase of the source of the system as well as its frequency may be achieved by a controllable function generator implemented with a field-programmable gate array (FPGA) that applies an input signal to a radio frequency power amplifier AC source.

In another implementation of the system, instead of controlling the phase of the AC source 301 in the systems that excite the transmitter coil or coil array, there can be an amplitude control circuit that varies the amplitude of the AC voltage or current source according to the reflected impedance coming from the receiver.

This control circuit may allow for the amplitude to vary only between the 0 and 100% of the amplitude or inside the range 0-100%. An effective change in the amplitude of the AC source 301 can be achieved by applying a change in the DC input of the DC-AC converter 302. In other implementations the frequency of the AC source 301 can be changed by modifying and operating the clock source of a radio frequency power amplifier.

In the case of a wireless power transmitter device that includes a switching network 203 as shown in FIGS. 2A-2C, the operation of the switching network can be achieved by the operation or state setting of at least one switching element. The switching elements may, for example, be embodied by AC switches with transistors connected back-to-back or by solid-state relays or by mechanical switches.

A change in the equivalent impedance of the coils in the 3-dimensional array 205 or the one or more coils 202 electrically connected to the power source 200 can be achieved by detuning via another strongly-coupled resonator circuit, by physical removal or a conductive track that will effectively impede the flow of electrons in the resonator(s) or by a direct detuning or switching. This variation between states, regarded as switching can be achieved by the use of a single or a combination of transistors including but not limited to field-effect transistor (FET), metal-oxide-semiconductor field-effect transistor (MOSFET), gallium nitride (GaN), gallium nitride high-electron-mobility transistor (GaN HEMT), among others.

In some embodiments of the presented technology, the transmitter device 101 can have at least one capacitive element electrically coupled to the at least one coil 202 or 205 either direction or through the switching network 203 as to create inductive-capacitive resonant circuits with a certain resonance frequency. An effective change in impedance can also be achieved by addition of fixed or variable capacitors that can be connected with the coils to create the resonance circuits.

The communication between the transmitter device 101 and the receiver device 108 can also be performed via the wireless power transmission channel 107 itself. This can be achieved by having resonators with a wider bandwidth and with two resonance frequencies that allow to send a wireless power signal that is not composed of a single component. For example, the wireless power signal may be modulated in amplitude by a carrier signal. In this other implementation, the transmitter and receiver devices may require modulator and demodulator stages, respectively.

The purpose of the visualization unit 105 is to inform the user about the active wireless power transfer volume, also called the volumetric zone, around the transmitter device 101 so that the user can either place the at least one receiver device 108 inside the volume in which the receiver device can receive wireless power coming from the transmitter device 101 or to inform the user about the current inactive volume around the transmitter device that has the ability to reconfigure their active/inactive volume so that he can place foreign objects close to the transmitter device inside the inactive volume and not have the correct operation of the transmitter device disturbed. This is of particular importance when placing metallic or ferromagnetic objects close to the transmitter device.

FIG. 5A shows a schematic diagram illustrating an embodiment of a visualization unit 105 according to the disclosure. In this embodiment, the visualization unit is embodied as a physical template 105, i.e., by using passive components.

The visualization unit 105 comprises a physical template 105 with the dimension and profile of the expected wireless power availability volume of a wireless power transmitter device whose wireless power profile is fixed.

The template 105 in this embodiment can be considered as a projection of the charging volume or volumetric zone that the transmitter device is able to generate. This is of importance, because the template 105 is signalizing an area but the wireless power transmitters in FIGS. 2A-2C are able to create a charging volume around them, i.e., the at least one receiver device 108 can be supplied with wireless power as long as it is somewhere around the volume above the template and not only directly above the template as if the receiver 108 were supplied with wireless power from a mat-like wireless power transmitter.

FIG. 5B shows a schematic diagram illustrating another embodiment of a visualization unit according to the disclosure.

For the transmitter devices 101 with the ability to reconfigure the wireless power transfer profile around them, another embodiment of the visualization unit 105 using a combination of passive and active components is shown in FIG. 5B.

In this case, the visualization unit 105 comprises light sources of different colors and passive displaying elements such as the pre-defined templates with colored patterns and profiles located underneath the wireless power transmitter device 101. The colors of the predefined templates significantly match the colors of the light sources.

The control unit 103 can be operated to reconfigure the wireless power transmitter device 101 to produce a wireless power transfer volume that matches the projected profile of the predefined template as well as the corresponding light source in such a manner that the user is informed in which mode the wireless power transmitter device is currently operating according to the information obtained by the receiver detection unit 104, for example, if the user re-located the at least one receiver device from one place to another so that the wireless power transfer can still be carried on.

FIG. 6 shows schematic diagrams illustrating other embodiments of a visualization unit according to the disclosure.

The visualization unit 105 of a wireless power transmitter 101 can be configured to create three different wireless power transfer profiles (a)-(c) or three different wireless power transmitters (d)-(f) that have a unique wireless power transfer profile.

In this case, the visualization unit 105 comprises active and passive elements like light sources, light conducting elements, light scattering elements and it is operated to provide a visual representation of the active side of the reconfigurable wireless power transmitter device or the single-mode transmitter devices. The transmitters (d)-(f) demonstrate light strips on the side walls of the transmitter or transmitters 101. The transmitters (g)-(i) show light panels on top of the transmitter or transmitters 101. The visualization unit 105 may be embodied as well as by a virtual representation of the predefined templates on a smartphone, like depicted in FIG. 6j.

FIG. 7 shows a schematic diagram illustrating another embodiment of a visualization unit according to the disclosure.

The visualization unit 105 of a wireless power transmitter 101 can be configured to create two different wireless power transfer profiles (a)-(b) or two different wireless power transmitters (c)-(d) that have a unique wireless power transfer profile.

In this case, the visualization unit 105 can be an optical unit comprising active and passive elements such as light sources, mask pattern slides, projection lenses. At least one projection lens may be operated to provide a visual representation of the active side around of the reconfigurable wireless power transmitter device or the single-mode transmitter devices.

The shape of the light being reflected on the surface onto which the transmitter device is placed significantly matches the profile and dimension of the expected wireless power availability volume of the wireless power transmitter. This shape can be considered as a projection of the charging volume that the transmitter device is able to generate.

FIG. 8 shows a schematic diagram illustrating an embodiment of a wireless transmitter device 101 with a user interface according to the disclosure.

As described above with respect to FIG. 1, the wireless power transmitter device 101 may comprise a user interface. The wireless power transmitter device 101 can be operated by the user and a control unit to wirelessly power or charge electric or electronic device(s) by reconfiguring the wireless power transfer profile.

For example, such a user interface may include a press-button, a mechanical switch whose actuator is in reach of the user and/or a manual selection of an operation mode of the transmitter device 101 on a touch display located onto the transmitter device 101 or activated wirelessly by information obtained via electromagnetic waves 409 between a wireless communication stage 405 of the receiver device 108 and a wireless communication stage 404 of the transmitter device 101, as shown in FIG. 4, for example.

The information obtained by the user may over-ride the currently active operation mode of the transmitter device 101 or the information coming from a receiver detection unit.

For example, the information obtained by the user may over-ride the desired operation mode of the reconfiguration unit 403 shown in FIG. 4 or the phase/amplitude/frequency controller 401 shown in FIG. 4 according to the information coming from the receiver detection unit 104 as shown in FIG. 4.

FIG. 9 shows a flow chart illustrating an exemplary operation of a wireless power transmitter device 101 according to the disclosure.

As described above with respect to FIG. 1, the wireless power transmitter device 101 may comprise a receiver detection unit, e.g., a receiver detection unit 104 as described in more detail above with respect to FIG. 4.

FIG. 9 shows a flow chart to operate a wireless power transmitter device 101 that may have no reconfiguration capabilities. This means that the wireless power transfer profile that this device is able to generate has a fixed characteristic in space. However, such a device can still be able to provide the user feedback for his convenience. Said operating and controlling method may comprise the following steps to which it is not limited to:
1) Starting operation of the wireless power transmitter device 101.
2) If a receiver device 108 configured to receive the wireless power from the wireless power transmitter device 101 is detected by the receiver detection unit 104 within a predefined range 1310, the following items may be performed:
3) The control unit of the transmitter device 101 assesses if the at least one receiver device 108 is inside the volumetric zone 1320, i.e., the volume in which the wireless power transmitter device 101 can supply wireless power to the receiver device 108.
3a) When supplying wireless power is possible, the control unit instructs the wireless power transmitter device 101 to initiate a wireless power transfer protocol to the receiver device 108 and may additionally inform the user about the active wireless power transfer volume around the transmitter device 101.
3b) When supplying wireless power is not possible, the control unit may indicate the user that no power supply is possible, e.g., by using a visualization unit to call for the user's attention by, for instance, performing light blinking or dimming effects to inform the user about the active wireless power transfer volume 1320 around the transmitter device in which the transmitter device 101 is capable of providing wireless power to the receiver device 108.
4) While the transmitter device 101 is active, the above loop, i.e., items 2), 3), 3a) and 3b) may be repeated.

This method may also assess if the current condition is the same as the condition from the last cycle to avoid turning on and off the wireless power supply 102 continuously or keep informing the user about the active wireless power transfer volume around the transmitter device in which the transmitter device 101 is capable of providing wireless power to the receiver device 108.

This method may also comprise not only delays but also other evaluation of conditions to assess if the current condition is the same as the condition from the last cycle to avoid turning on and off the wireless power supply 102 continuously or keep informing the user about the active wireless power transfer volume around the transmitter device in which the transmitter device 101 is capable of providing wireless power to the receiver device 108.

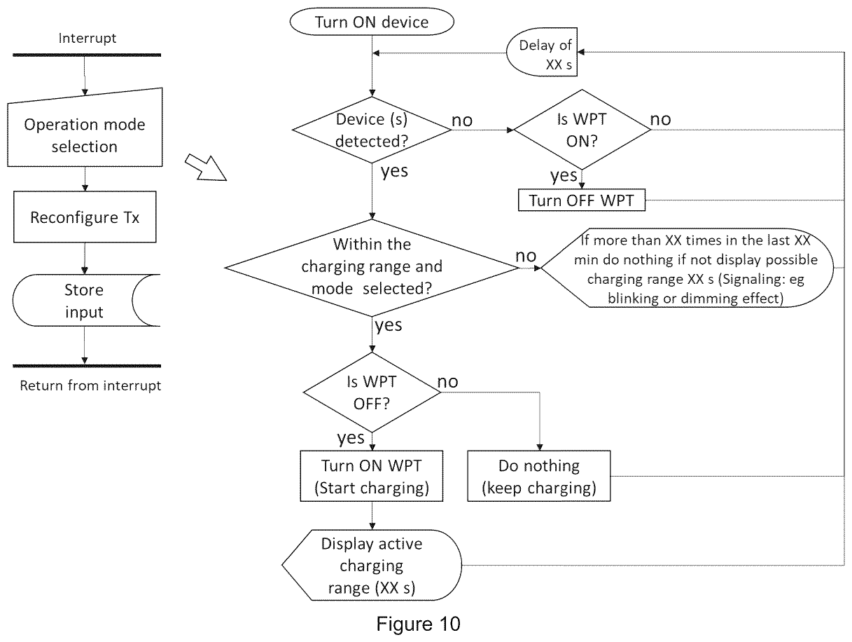

FIG. 10 shows a flow chart illustrating another exemplary operation of a wireless power transmitter device 101 according to the disclosure.

FIG. 10 shows yet another operation and control method of the disclosed wireless power transmitter devices. This flowchart refers to a wireless power transmitter device 101 with the possibility of reconfiguration according to the information obtained from the user interface according to the device presented in FIG. 8. The operation and control method may comprise the same steps as those of the flowchart in FIG. 9 with some differences like:
1) The wireless power supply 102 is configured at device turn on in a default operation and it will continue to operate in such a mode unless the device is interrupted by user interface.
2) An interrupt will occur if and when a different operation mode is selected by the user through the user interface 800, see FIG. 8, which will reconfigure the wireless power supply 102 to operate in such mode.

Operating in a specific mode selected by the user or assigned by default at device start-up means that the wireless power transmitter device 101 will only provide wireless power transfer to the at least one receiver device 108 within the charging volume corresponding to this operation mode.

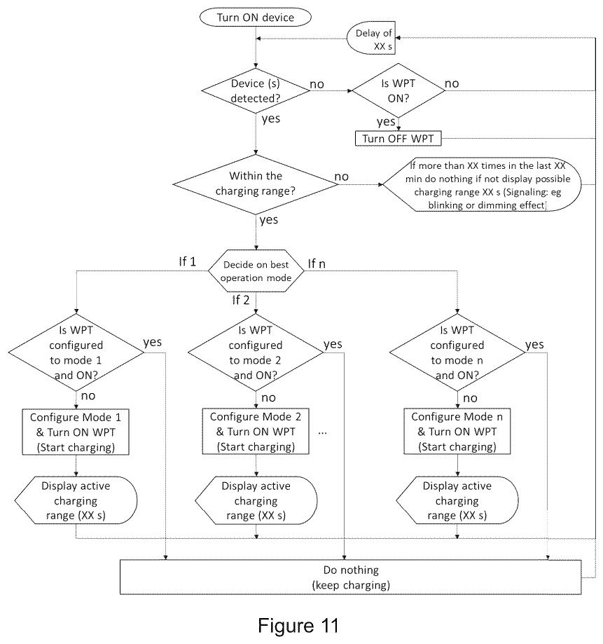

FIG. 11 shows a flow chart illustrating another exemplary operation of a wireless power transmitter device 101 according to the disclosure.

FIG. 11 shows a further operation and control method of the disclosed wireless power transmitter devices. In this case the method described therein applies to a wireless power transmitter device 101 with reconfiguration capabilities but instead of offering the possibility to the user to manually set the operation mode, the wireless power supply 102 is automatically reconfigured by the control unit 103, see FIG. 1, to change the wireless power transfer profile according to the information obtained by operating the receiver detection unit 104. This requires the receiver detection unit 104 to assess if the at least one receiver device 108 has been placed inside the volume in which the wireless power transmitter 101 can supply it with wireless power or if another receiver device 108 enabled to receive the wireless power from the transmitter enters into this volume. Then the wireless power transmitter can be reconfigured into an operation mode that supplies to both receiver devices.

If the at least one receiver device 108 is within the volume in which the transmitter device 101 can supply with wireless power (if yes), the control unit 103 determines which of the operating modes of the wireless power supply 102 is the most suitable according to the information obtained by the receiver detection unit, reconfigures the transmitter device to operate in such a mode, initiates a wireless power transfer protocol to the receiver device, and operates the visualization unit 105 to inform the user about the active wireless power transfer volume around the transmitter device.

If the receiver device is not in range of the wireless power transfer profile but it is in range of the receiver detection unit 104, the control unit 103 may operate the visualization unit 105 to call the user's attention by, for instance, performing light blinking or dimming effects to inform the user about the active wireless power transfer volume around the transmitter device 101 in which the transmitter device 101 is capable of providing wireless power to the receiver device 108.

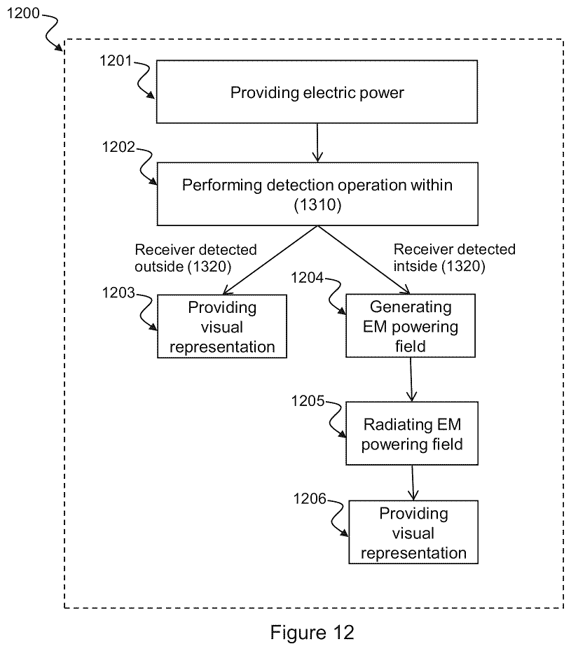

FIG. 12 shows a schematic diagram illustrating a method 1200 for visualizing information about a volumetric zone of a transmitter device 101 according to the disclosure.

Such a transmitter device 101 radiates an electromagnetic powering field 107 for wirelessly powering at least one receiver device 108, e.g., as described above with respect to FIGS. 1 to 11.

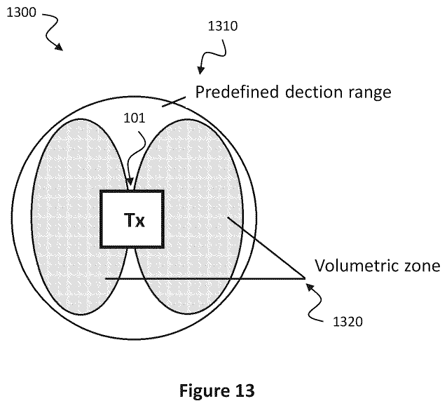

The method 1200 comprises the following: providing 1201 electric power by a power source 200; performing 1202, by a receiver detection unit 104, a detection operation for detecting at least one receiver device 108 inside a predefined range 1310, also referred to as predefined detection range 1310 as shown in FIG. 13, from the transmitter device; when a receiver device 108 is detected inside the predefined range but outside the volumetric zone 1320, providing 1203, by a visualization unit 105, a visual representation of the volumetric zone 1320 in which the transmitter device 101 is capable of providing wireless power, e.g., volumetric zone 1320 as shown in FIG. 13, of the transmitter device 101; when a receiver device 108 is detected inside the volumetric zone 1320, generating 1204 the electromagnetic powering field 107 by at least one coil 202 electrically connected to the power source 200, the electromagnetic powering field 107 emanating from the at least one coil 202, e.g., as described above with respect to FIGS. 1 to 11; radiating 1205 the electromagnetic powering field 107 towards the volumetric zone by the at least one coil 202, e.g., as described above with respect to FIGS. 1 to 11; and providing 1206, by the visualization unit 105, a visual representation of the characteristic of the electromagnetic powering field 107 radiated towards the receiver device 108, e.g., as described above with respect to FIGS. 1 to 11.

FIG. 13 shows a schematic diagram illustrating a wireless transmitter device 101 according to the disclosure with a predefined detection area 1310 and charging area or volumetric zone 1320.

The main idea behind the visualization unit 105 is to aid the user to place the device in the supported range.

The predefined range 1310 in which the receiver detection unit 104 is capable of detecting a receiver 108 can be the same or larger than the volumetric zone 1320 towards which the transmitter device 101 is capable of sending wireless power.

The receiver detection unit 104 may be capable of detecting a receiver 108 in one, two or three dimensions.

While a particular feature or aspect of the disclosure may have been disclosed with respect to only one of several implementations, such feature or aspect may be combined with one or more other features or aspects of the other implementations as may be desired and advantageous for any given or particular application. Furthermore, to the extent that the terms “include”, “have”, “with”, or other variants thereof are used in either the detailed description or the claims, such terms are intended to be inclusive in a manner similar to the term “comprise”. Also, the terms “exemplary”, “for example” and “e.g.” are merely meant as an example, rather than the best or optimal. The terms “coupled” and “connected”, along with derivatives may have been used. It should be understood that these terms may have been used to indicate that two elements cooperate or interact with each other regardless whether they are in direct physical or electrical contact, or they are not in direct contact with each other.

Although specific aspects have been illustrated and described herein, it will be appreciated by those of ordinary skill in the art that a variety of alternate and/or equivalent implementations may be substituted for the specific aspects shown and described without departing from the scope of the disclosure. This application is intended to cover any adaptations or variations of the specific aspects discussed herein.

Although the elements in the following claims are recited in a particular sequence with corresponding labeling, unless the claim recitations otherwise imply a particular sequence for implementing some or all of those elements, those elements are not necessarily intended to be limited to being implemented in that particular sequence.

Many alternatives, modifications, and variations will be apparent to those skilled in the art in light of the above teachings. Of course, those skilled in the art readily recognize that there are numerous applications of the disclosure beyond those described herein. While the disclosure has been described with reference to one or more particular embodiments, those skilled in the art recognize that many changes may be made thereto without departing from the scope of the disclosure. It is therefore to be understood that within the scope of the appended claims and their equivalents, the disclosure may be practiced otherwise than as specifically described herein.

1. A transmitter device comprising:
a power source configured to provide electric power;
at least one coil electrically connected to the power source, wherein the at least one coil is configured to:
generate an electromagnetic powering field emanating from the at least one coil; and
radiate the electromagnetic powering field towards a volumetric zone for powering at least one receiver device located in the volumetric zone;
a plurality of second coils arranged to form a three-dimensional coil array, wherein the three-dimensional coil array is electromagnetically coupled via the electromagnetic powering field to the at least one coil, wherein the three-dimensional coil array is configured to:
generate a second electromagnetic field emanating from the three-dimensional coil array; and
radiate the second electromagnetic field towards the volumetric zone; and
a visualization device configured to provide a visual representation of a characteristic of the electromagnetic powering field.

2. The transmitter device of claim 1, wherein the characteristic comprises at least one of a transmission range, an active area, a wireless power profile, a radiation pattern, a flux line configuration, or a beam density around the transmitter device.

3. The transmitter device of claim 1, wherein the characteristic is based on at least one of a magnitude, a phase and a frequency of the electric power provided by the power source, an impedance of the at least one coil, or an impedance of a coil configuration of the at least one receiver device.

4. The transmitter device of claim 1, wherein the at least one coil is further configured to:
further generate the electromagnetic powering field as a volumetric wireless power profile; and
further radiate the volumetric wireless power profile towards the volumetric zone.

5. The transmitter device of claim 4, wherein the volumetric wireless power profile is based on at least one of receiver information of the at least one receiver device, a user input, a change in first operational parameters of the transmitter device, or a change in second operational parameters of the at least one receiver device.

6. The transmitter device of claim 5, further comprising a user interface configured to receive the user input, wherein the user interface comprises at least one of a press-button, a mechanical switch, a touch display, or a communication interface with a remote user interface.

7. The transmitter device of claim 5, wherein the receiver information comprises information about at least one of an orientation, a position, or load changes of the at least one receiver device.

8. The transmitter device of claim 5, wherein the first operational parameters comprise at least one of a magnitude, a phase, a frequency of the electric power provided by the power source, or an impedance of the at least one coil.

9. The transmitter device of claim 1, further comprising:
a receiver detector configured to detect the at least one receiver device; and
a controller configured to enable powering of the at least one receiver device.

10. The transmitter device of claim 9, wherein the receiver detector is further configured to detect at least one moved receiver device that moved away from the volumetric zone, and wherein the controller is further configured to disable powering the at least one moved receiver device.

11. The transmitter device of claim 1, further comprising a reconfigurable switching network coupled between the power source and the plurality of second coils, wherein the reconfigurable switching network comprises a plurality of switches, wherein the plurality of switches is configured to interconnect coils from the plurality of second coils according to a predetermined switching configuration in order to obtain the three-dimensional coil array, wherein the three-dimensional coil array is further configured to further radiate, based on the predetermined switching configuration, the second electromagnetic field towards the volumetric zone.

12. The transmitter device of claim 1, further comprising a first coil corresponding to the at least one coil, wherein the first coil is electrically connected to the power source to generate a first electromagnetic field emanating from the first coil.

13. The transmitter device of claim 1, wherein the visualization device comprises at least one of light sources, light conducting elements, or light scattering elements.

14. The transmitter device of claim 1, further comprising:
a top side;
a bottom side opposing the top side; and
a plurality of side walls,
wherein the visualization device is configured to:
provide light strips on one or more side walls of the plurality of side walls, wherein the one or more side walls with the light strips are aligned towards the volumetric zone; or
provide light panels on the top side, wherein the light panels are directed towards the volumetric zone.

15. The transmitter device of claim 1, further comprising a box housing the power source and the at least one coil, wherein the visualization device comprises a physical template for positioning at a predefined position underneath the box, and wherein a shape and a profile of the physical template is configured to visualize the volumetric zone.

16. The transmitter device of claim 15, wherein the physical template comprises at least one of colored or patterned areas, wherein the visualization device comprises light elements configured to emit light in different spectra to generate emitted spectra or to emit different light patterns to generate emitted light patterns, and wherein at least one of the emitted spectra or the emitted light patterns correspond to the at least one of colored or patterned areas of the physical template in order to visualize the volumetric zone.

17. The transmitter device of claim 15, further comprising a communication device, wherein the communication device comprises:
a display; and
a communication interface configured to transmit information for displaying a representation of the physical template on the display.

18. The transmitter device of claim 1, wherein the visualization device comprises an optical circuit, wherein the optical circuit comprises at least one of light sources, mask pattern slides, or at least one projection lens, and wherein the optical circuit is configured to provide a projection of the volumetric zone on a surface onto which the transmitter device is placed.

19. A wireless powering system, comprising:
a transmitter device comprising:
a power source configured to provide electric power;
at least one coil electrically connected to the power source, wherein the at least one coil is configured to:
generate an electromagnetic powering field emanating from the at least one coil; and
radiate the electromagnetic powering field towards a volumetric zone;
a plurality of second coils arranged to form a three-dimensional coil array, wherein the three-dimensional coil array is electromagnetically coupled via the electromagnetic powering field to the at least one coil, wherein the three-dimensional coil array is configured to:
generate a second electromagnetic field emanating from the three-dimensional coil array; and
radiate the second electromagnetic field towards the volumetric zone; and
a visualization device configured to provide a visual representation of a characteristic of the electromagnetic powering field; and
at least one receiver device configured to receive the electromagnetic powering field upon movement into the volumetric zone.

20. A method for visualizing information about a volumetric zone of a transmitter device, the method comprising:
providing electric power by a power source;
performing, by a receiver detector, a detection operation for detecting at least one receiver device inside a predefined range;
providing, by a visualization device when the receiver detector detects the at least one receiver device inside the predefined range but outside the volumetric zone, a first visual representation of the volumetric zone towards which the transmitter device can radiate an electromagnetic powering field,
when the receiver detector detects the at least one receiver device inside the volumetric zone,
generating the electromagnetic powering field by at least one coil electrically connected to the power source, wherein the electromagnetic powering field emanates from the at least one coil;
radiating, by the at least one coil, the electromagnetic powering field towards the volumetric zone;
providing, by the visualization device, a second visual representation of a characteristic of the electromagnetic powering field;
generating, by a plurality of second coils arranged to form a three-dimensional coil array, a second electromagnetic field emanating from the three-dimensional coil array, wherein the three-dimensional coil array is electromagnetically coupled via the electromagnetic powering field to the at least one coil; and
radiating, by the plurality of second coils, the second electromagnetic field towards the volumetric zone.
